(19) United States
(12) Patent Application Publication
(10) Pub. No.: US 2006/0262860 A1
(43) Pub. Date: Nov. 23, 2006

(54) Macroblock adaptive frame/field coding architecture for scalable coding

(76) Inventors: Jim Chen Chou, San Jose, CA (US); Ali Tabatabai, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/361,706

(22) Filed: Feb. 23, 2006

Related U.S. Application Data
(60) Provisional application No. 60/655,943, filed on Feb. 23, 2005.

(51) Int. Cl. H04N 11/04; H04N 11/02; H04N 7/12; H04B 1/66

(52) U.S. Cl. 375/240.24; 375/240.25

(57) ABSTRACT

An open loop encoding architecture encodes a sequence of interlaced video frames at macroblock level. In one aspect, each frame is divided into pairs of macroblocks and the macroblock pairs are encoded as either separate macroblocks or as two fields, depending upon a motion threshold. Predictors for the macroblock pairs may be selected from different frames in the sequence, or from frames of different resolution. In another aspect, a frame may be open loop encoded at field level instead of at macroblock level. A corresponding inverse open loop encoding architecture is used to decode the encoded frames.

### RELATED APPLICATIONS

This application claims the benefit of U.S. Provisional Application 60/655,943 filed Feb. 23, 2005, which is hereby incorporated by reference.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. Copyright© 2005, Sony Electronics, Inc., All Rights Reserved.

### FIELD OF THE INVENTION

This invention relates generally to video coding, and more particularly to scalable video coding.

### BACKGROUND OF THE INVENTION

A frame of video consists rows of pixels and is commonly viewed as comprising two interleaved sets of rows, called fields. The even rows are often referred to as the top field, while the odd rows are referred to as the bottom field. If the pixels in both fields were captured at the same time, the frame is called a progressive frame, while a frame with fields captured at different times is called an interlaced frame. In addition, a frame also may be partitioned into macroblocks, each having a pre-determined number of pixels. A macroblock thus contains pixels belonging to both top and bottom fields of the frame.

Video streams are encoded prior to being transmitted or recorded on digital media. However, in the wake of rapidly increasing demand for network, multimedia, database and other digital capacity, many different multimedia coding and storage schemes have evolved. The Moving Picture Experts Group (MPEG) developed the MPEG-4 file format, also referred to as MP4 (ISO/IEC 14496-14, Information Technology—Coding of audio-visual objects—Part 14: MP4 File Format). The Joint Photographic Experts Group (JPEG) developed a file format for JPEG 2000 (ISO/IEC 15444-1). Subsequently, MPEG's video sub-group and the Video Coding Experts Group (VCEG) of International Telecommunication Union (ITU) began working together as a Joint Video Team (JVT) to develop a new video coding/decoding (codec) standard. The new standard is referred to both as the JVT codec and the ITU Recommendation H.264, or MPEG-4-Part 10, Advanced Video Codec (AVC).

The increase in video transmission over networks with different bandwidths requires that video be scalable to provide acceptable quality. MPEG has proposed a scalable video coding (SVC) architecture, but the SVC architecture only supports progressive video. AVC provides two different types of single layer video encoding: picture adaptive frame/field coding (PAFF) and macroblock adaptive frame/field coding (MBAFF). PAFF operates at the frame level and either encodes both fields of a frame together (frame mode) or encodes each field separately (field mode). MBAFF operates at the macroblock level and encodes the fields in a macroblock together (frame mode) or separately (field mode). The AVC macroblock adaptive coding architectures use differential pulse code modulation (DPCM) when encoding interlaced video. However, MBAFF is limited to the use of closed loop encoding, which is not suitable for interlaced video.

### SUMMARY OF THE INVENTION

An open loop encoding architecture encodes a sequence of interlaced video frames at macroblock level. In one aspect, each frame is divided into pairs of macroblocks and the macroblock pairs are encoded as either separate macroblocks or as two fields, depending upon a motion threshold. Predictors for the macroblock pairs may be selected from different frames in the sequence, or from frames of different resolution. In another aspect, a frame may be open loop encoded at field level instead of at macroblock level. A corresponding inverse open loop encoding architecture is used to decode the encoded frames.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

FIG. 1 is a diagram illustrating a system-level overview of an embodiment of the invention;

FIG. 2A is a block diagram of an exemplary open loop architecture employed by an encoder;

FIG. 2B is a block diagram of an exemplary open loop architecture employed by a decoder;

FIG. 3 is an illustration of the operation of the open loop architecture of FIG. 2;

FIG. 4 is an illustration of predicting a pair of macroblocks from past and future macroblocks;

FIG. 5 is an illustration of field encoding a pair of macroblocks according to one embodiment of the invention;

FIG. 6A is a flowchart of an encoding method to be performed by an encoder according to an embodiment of the invention;

FIG. 6B is a flowchart of a corresponding decoding method to be performed by a decoder;

FIG. 7A is a diagram of one embodiment of an operating environment suitable for practicing the present invention; and

FIG. 7B is a diagram of one embodiment of a computer system suitable for use in the operating environment of FIG. 7A.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

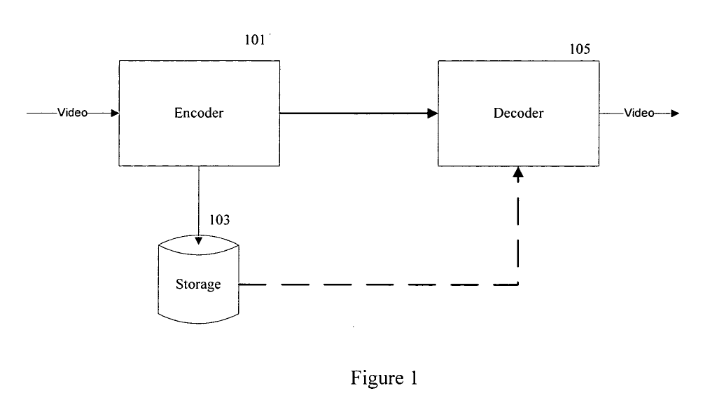

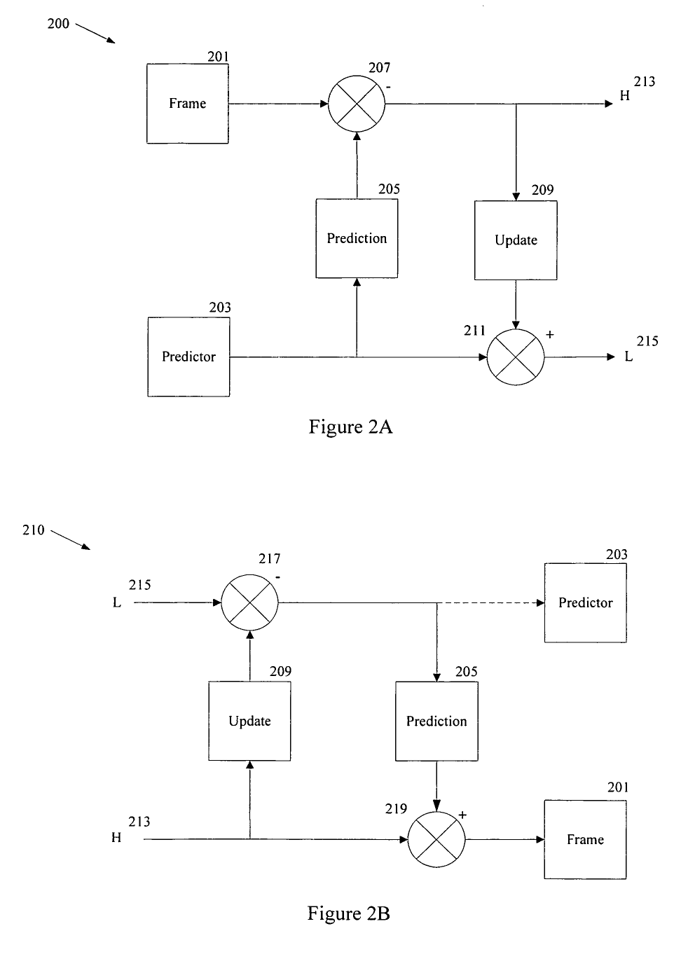

A system level overview of the operation of an embodiment of the invention is described by reference to FIG. 1. An encoder 101 employs picture adaptive frame/field coding (PAFF) and macroblock adaptive frame/field coding (MBAFF) techniques in an open loop architecture to encode interlaced video frames. The encoded frames may be transmitted to a decoder 105 or stored in a storage device 103 for subsequent transmission to a decoder 105. To reduce the amount of data used to present the video, certain frames are predicted from other frames using an open loop architecture, such as illustrated in FIG. 2A.

A prediction operation 205 predicts a frame 201 from a related frame, referred to as a predictor 203. The predictor 203 can be a past or a future frame relative to the frame 201, or some combination of the two. Operation 207 calculates the difference between the output of the prediction operation 205, i.e., the predicted frame, and the actual frame 201, which is referred to as the residue or prediction error. The residue is input in to an update operation 209 and the output of the update operation is added 211 into predictor 203. The output of the open loop architecture is the residue 213 and the updated predictor 215, which are subsequently sent to the decoder 105 as two frames. It will be appreciated that the predictor 203 may be an updated predictor 213 (e.g., temporal low pass) from a previous recursion when the open architecture 200 is processing a sequence of video frames. Thus, the open loop architecture of FIG. 2A reduces two video frames into a single frame (e.g., low pass) and a residue frame (e.g. high pass). When the predictors are selected based on motion vectors, this type of encoding is referred to a motion compensated temporal filtering (MCTF) decomposition. In addition, spatial scalability can be achieved by selecting predictors from frames of lower resolution in addition to, or in place of, predictors having the same resolution as the frame to be predicted.

FIG. 2B illustrates an inverse open-loop architecture 210 that is incorporated into the decoder 105. It will be appreciated that the update and prediction operations are the same as those used to encode the video frame, except that they are performed in reverse order and by switching the signs. The residue 213 is updated 209 and the result is subtracted 217 from the updated predictor 215 to recover the original predictor 203. The prediction operation 205 is performed on the original predictor 203 and the residue is added 219 to the predicted frame to recover the original frame 201.

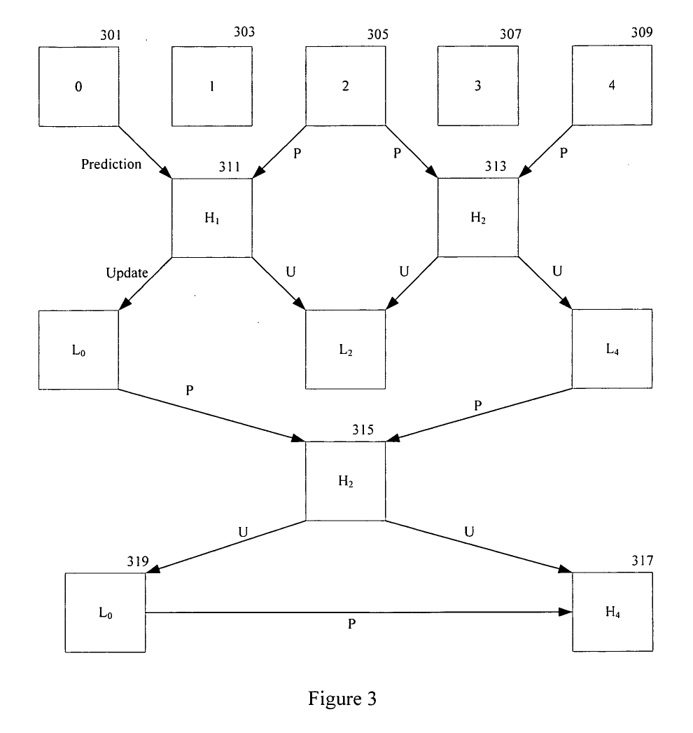

As described above, the processing of the FIG. 3 illustrates the decomposition of a video sequence of N frames 301, 303, 305, 307 and 309 into a single predictor frame 319, and N−1 residue frames 311, 313, 315, and 317. The predictor frame and the residue frames are sent to the decoder along with flags and other information needed by the decoder to decode the video. Note that in FIG. 3, both a past frame (301, 305) and a future frame (305, 309) are used as predictors for the frame (303, 307) that temporally occurs between them.

For a sequence of interlaced video frames, the predictors can be fields, as in PAFF, or macroblocks, as in MBAFF. At the field level, the prediction and update operations are performed separately for each field. Two predictors for each field are either 1) the two fields in the past frame, 2) the two fields in the future frame, or 3) one field from each of the past and future frames. In an alternate embodiment, the predictors are a weighted combination of the fields in the past frame and the fields in the future frame.

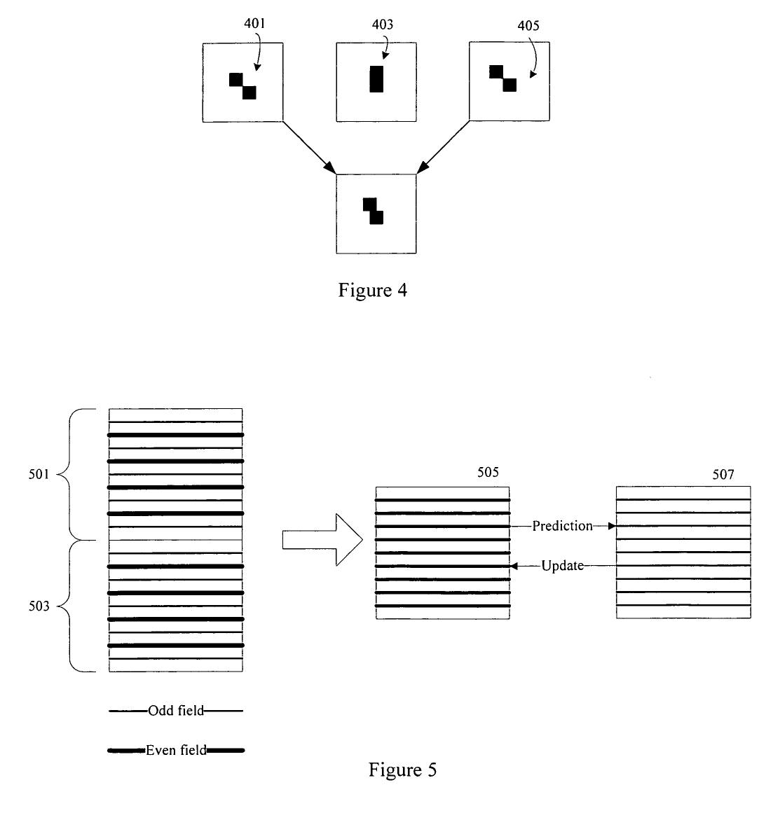

At the macroblock level, each frame is divided into pairs of macroblocks 401, 403, 405 as shown in FIG. 4. The pair of macroblocks can be coded as two separate macroblocks, as in MBAFF frame coding, or as two separate fields, i.e., two new macroblocks are created, one of which contains the even fields and the other the odd fields for the original macroblock pair. When coding a macroblock pair 403 as separate fields, the predictors are fields from the corresponding macroblocks 401, 403 in the past and/or future frames. The subsequent update operation is applied separately to the predictor fields.

FIG. 5 is an example of coding a macroblock pair as two separate fields. Each macroblock 501, 503 contains both odd and even fields. In this example, the even fields 505 serve as the predictors for the odd fields 507, with the residual between the two fields 505, 507 being used to update the even fields 505. In an alternate embodiment, the fields are predicted from both a past and a future field, with the update being applied to both predictor fields. The predictors can also come from fields of lower resolution to provide scalability. In one embodiment, the predictors come from fields of lower spatial resolution for spatial scalability, while in another embodiment the predictors come from fields of lower signal-to-noise (SNR) resolution.

One of skill in the art will recognize that processing in this example is equivalent to using a Haar lifting structure between the odd and even fields. However, the invention is not so limited and higher order lifting schemes are contemplated to improve the prediction and update operations. Accordingly, in an alternate embodiment, a 5/3 or a 13/5 lifting structure is applied to the horizontal lines of the even and odd fields 505, 507 along the vertical direction.

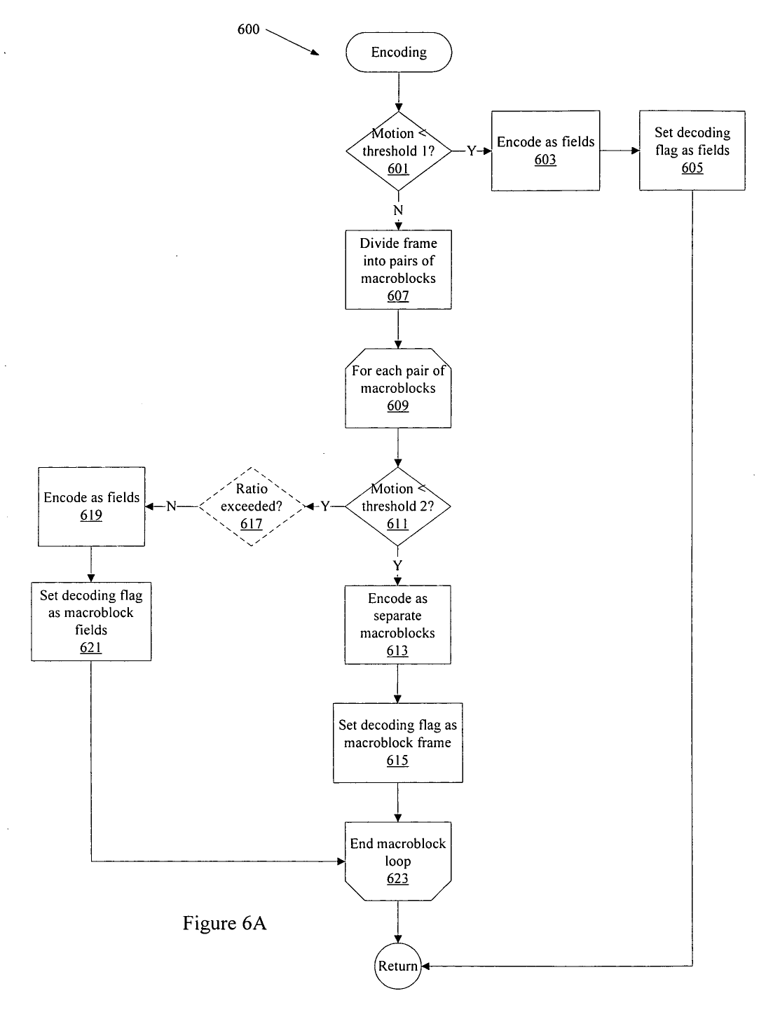

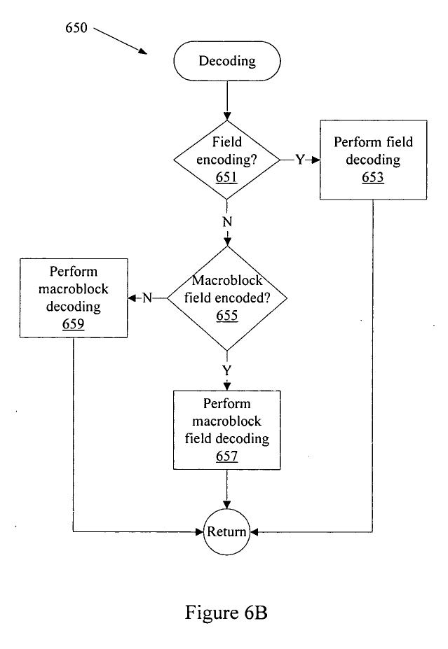

One embodiment of a encoding method to be performed by the encoder 101 of FIG. 1 is described with reference to a flowchart shown in FIG. 6A. A corresponding decoding method to be performed by the decoder 105 is described with reference to a flowchart shown in FIG. 6B.

Referring first to FIG. 6A, the acts to be performed by a processor executing the encoding method 600 are described. Prior to invoking method 600, the processor or another component has performed motion analysis on the sequence of interlaced video frames and determined that PAFF frame mode encoding is inappropriate for the current frame of video. The motion analysis and methodology of this decision are not described as they are not germane to the present invention. At block 601 the method 600 determines if the motion is less than a first threshold. If so, the frame is encoded at the field level as described above (block 603) and a decoding flag is set to inform the decoder of the field level encoding (block 605). If the motion meets or exceeds the first threshold, the method 600 divides the frames into pairs of macroblocks at block 607. This process also determines which pairs of macroblocks are appropriate predictors for other pairs of macroblocks based on, among other criteria, motion of the pixels of the video.

For each pair of macroblocks, the method 600 performs a processing loop starting at block 609 and ending at block 623. If the motion is less than a second threshold (block 611), the pair of macroblocks are coded as separate macroblocks at block 613 and the decoding flag is set as macroblock encoding at block 615. If the motion meets or exceeds the second threshold, the method 600 may optionally determine if encoding the macroblock pair as fields would exceed a cost-benefit ratio (block 617). If not, the method 600 encodes the pair of macroblocks as two fields at block 619 and sets the decoding flag appropriately (block 621). The cost-benefit ratio and the two thresholds are determined based on the particular attributes of the video being encoding.

Turning now to FIG. 6B, the acts to be performed by a processor executing the decoding method 650 are described. The processor invokes method 650 when a decoding flag signals that the frames were not encoded in PAFF frame mode. As described above in conjunction with FIG. 2B, the decoding process is the inverse of the encoding process. If the decoding flag signals that the frames were field encoded (block 651), the method 600 performs field decoding (block 655). If the decoding flag signals that the frames were macroblock field encoded (block 655), the method 600 decodes the fields of the macroblock pair at block 657. Otherwise, the method 600 decodes each macroblock of the pair separately at block 659 as frame macroblocks.

In practice, the methods 600, 650 may constitute one or more programs made up of machine-executable instructions. Describing the methods with reference to the flowcharts in FIGS. 6A-B enables one skilled in the art to develop such programs, including such instructions to carry out the operations (acts) represented by logical blocks 601 until 623, and 651 until 659 on suitably configured machines (the processor of the machine executing the instructions from machine-readable media). The machine-executable instructions may be written in a computer programming language or may be embodied in firmware logic or in hardware circuitry. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine causes the processor of the machine to perform an action or produce a result. It will be further appreciated that more or fewer processes may be incorporated into the methods illustrated in FIGS. 6A-B without departing from the scope of the invention and that no particular order is implied by the arrangement of blocks shown and described herein.

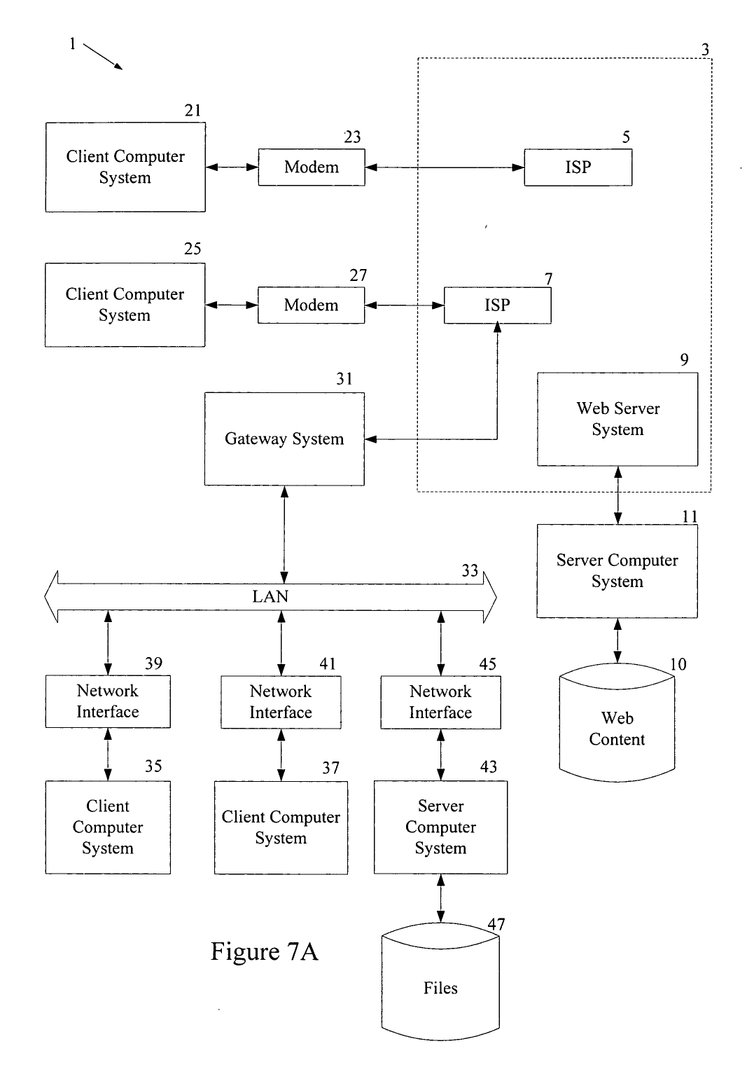

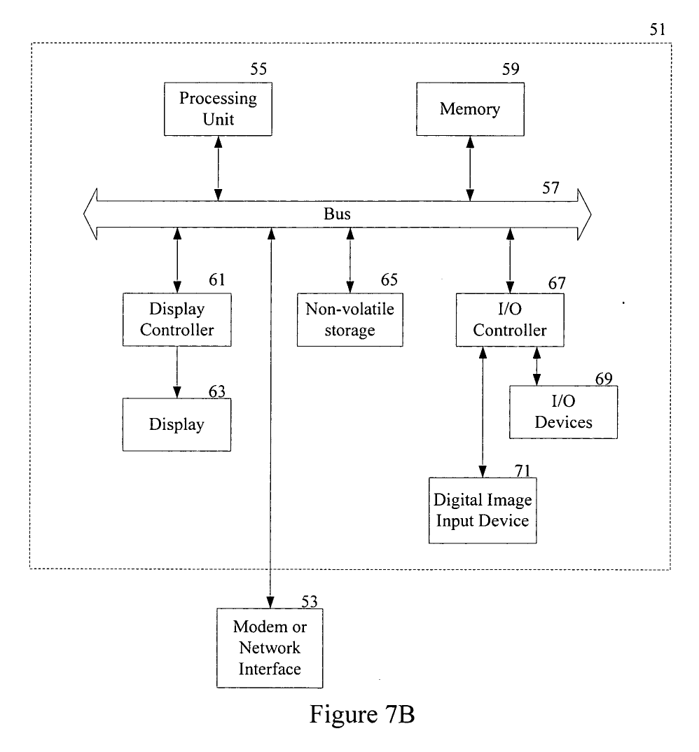

The following description of FIGS. 7A-B is intended to provide an overview of computer hardware and other operating components suitable for performing the methods of the invention described above, but is not intended to limit the applicable environments. One of skill in the art will immediately appreciate that the embodiments of the invention can be practiced with other computer system configurations, including hand-held devices, multiprocessor systems, microprocessor-based or programmable consumer electronics, network PCs, minicomputers, mainframe computers, and the like. The embodiments of the invention can also be practiced in distributed computing environments where tasks are performed by remote processing devices that are linked through a communications network, such as peer-to-peer network infrastructure.

FIG. 7A shows several computer systems 1 that are coupled together through a network 3, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 3 is typically provided by Internet service providers (ISP), such as the ISPs 5 and 7. Users on client systems, such as client computer systems 21, 25, 35, and 37 obtain access to the Internet through the Internet service providers, such as ISPs 5 and 7. Access to the Internet allows users of the client computer systems to exchange information, receive and send e-mails, and view documents, such as documents which have been prepared in the HTML format. These documents are often provided by web servers, such as web server 9 which is considered to be “on” the Internet. Often these web servers are provided by the ISPs, such as ISP 5, although a computer system can be set up and connected to the Internet without that system being also an ISP as is well known in the art.

The web server 9 is typically at least one computer system which operates as a server computer system and is configured to operate with the protocols of the World Wide Web and is coupled to the Internet. Optionally, the web server 9 can be part of an ISP which provides access to the Internet for client systems. The web server 9 is shown coupled to the server computer system 11 which itself is coupled to web content 10, which can be considered a form of a media database. It will be appreciated that while two computer systems 9 and 11 are shown in FIG. 7A, the web server system 9 and the server computer system 11 can be one computer system having different software components providing the web server functionality and the server functionality provided by the server computer system 11 which will be described further below.

Client computer systems 21, 25, 35, and 37 can each, with the appropriate web browsing software, view HTML pages provided by the web server 9. The ISP 5 provides Internet connectivity to the client computer system 21 through the modem interface 23 which can be considered part of the client computer system 21. The client computer system can be a personal computer system, a network computer, a Web TV system, a handheld device, or other such computer system. Similarly, the ISP 7 provides Internet connectivity for client systems 25, 35, and 37, although as shown in FIG. 7A, the connections are not the same for these three computer systems. Client computer system 25 is coupled through a modem interface 27 while client computer systems 35 and 37 are part of a LAN. While FIG. 7A shows the interfaces 23 and 27 as generically as a “modem,” it will be appreciated that each of these interfaces can be an analog modem, ISDN modem, cable modem, satellite transmission interface, or other interfaces for coupling a computer system to other computer systems. Client computer systems 35 and 37 are coupled to a LAN 33 through network interfaces 39 and 41, which can be Ethernet network or other network interfaces. The LAN 33 is also coupled to a gateway computer system 31 which can provide firewall and other Internet related services for the local area network. This gateway computer system 31 is coupled to the ISP 7 to provide Internet connectivity to the client computer systems 35 and 37. The gateway computer system 31 can be a conventional server computer system. Also, the web server system 9 can be a conventional server computer system.

Alternatively, as well-known, a server computer system 43 can be directly coupled to the LAN 33 through a network interface 45 to provide files 47 and other services to the clients 35, 37, without the need to connect to the Internet through the gateway system 31. Furthermore, any combination of client systems 21, 25, 35, 37 may be connected together in a peer-to-peer network using LAN 33, Internet 3 or a combination as a communications medium. Generally, a peer-to-peer network distributes data across a network of multiple machines for storage and retrieval without the use of a central server or servers. Thus, each peer network node may incorporate the functions of both the client and the server described above.

FIG. 7B shows one example of a conventional computer system that can be used as a client computer system or a server computer system or as a web server system. It will also be appreciated that such a computer system can be used to perform many of the functions of an Internet service provider, such as ISP 5. The computer system 51 interfaces to external systems through the modem or network interface 53. It will be appreciated that the modem or network interface 53 can be considered to be part of the computer system 51. This interface 53 can be an analog modem, ISDN modem, cable modem, token ring interface, satellite transmission interface, or other interfaces for coupling a computer system to other computer systems. The computer system 51 includes a processing unit 55, which can be a conventional microprocessor such as an Intel Pentium microprocessor or Motorola Power PC microprocessor. Memory 59 is coupled to the processor 55 by a bus 57. Memory 59 can be dynamic random access memory (DRAM) and can also include static RAM (SRAM). The bus 57 couples the processor 55 to the memory 59 and also to non-volatile storage 65 and to display controller 61 and to the input/output (I/O) controller 67. The display controller 61 controls in the conventional manner a display on a display device 63 which can be a cathode ray tube (CRT) or liquid crystal display (LCD). The input/output devices 69 can include a keyboard, disk drives, printers, a scanner, and other input and output devices, including a mouse or other pointing device. The display controller 61 and the I/O controller 67 can be implemented with conventional well known technology. A digital image input device 71 can be a digital camera which is coupled to an I/O controller 67 in order to allow images from the digital camera to be input into the computer system 51. The non-volatile storage 65 is often a magnetic hard disk, an optical disk, or another form of storage for large amounts of data. Some of this data is often written, by a direct memory access process, into memory 59 during execution of software in the computer system 51. One of skill in the art will immediately recognize that the terms “computer-readable medium” and “machine-readable medium” include any type of storage device that is accessible by the processor 55 and also encompass a carrier wave that encodes a data signal.

It will be appreciated that the computer system 51 is one example of many possible computer systems which have different architectures. For example, personal computers based on an Intel microprocessor often have multiple buses, one of which can be an input/output (I/O) bus for the peripherals and one that directly connects the processor 55 and the memory 59 (often referred to as a memory bus). The buses are connected together through bridge components that perform any necessary translation due to differing bus protocols.

Network computers are another type of computer system that can be used with the embodiments of the present invention. Network computers do not usually include a hard disk or other mass storage, and the executable programs are loaded from a network connection into the memory 59 for execution by the processor 55. A Web TV system, which is known in the art, is also considered to be a computer system according to the embodiments of the present invention, but it may lack some of the features shown in FIG. 7B, such as certain input or output devices. A typical computer system will usually include at least a processor, memory, and a bus coupling the memory to the processor.

It will also be appreciated that the computer system 51 is controlled by operating system software which includes a file management system, such as a disk operating system, which is part of the operating system software. One example of an operating system software with its associated file management system software is the family of operating systems known as Windows® from Microsoft Corporation of Redmond, Wash. and their associated file management systems. The file management system is typically stored in the non-volatile storage 65 and causes the processor 55 to execute the various acts required by the operating system to input and output data and to store data in memory, including storing files on the non-volatile storage 65.

The encoder and decoder of the present invention may be implemented within a general purpose computer system, such as those illustrated in FIGS. 7A and 7B, or may be a device having a processor configured to only execute the encoding or decoding methods illustrated in FIGS. 6A and 6B. Although the invention as been described with reference to specific embodiments illustrated herein, this description is not intended to be construed in a limiting sense. It will be appreciated by those of ordinary skill in the art that any arrangement which is calculated to achieve the same purpose may be substituted for the specific embodiments shown and is deemed to lie within the scope of the invention. Accordingly, this application is intended to cover any such adaptations or variations of the present invention. Therefore, it is manifestly intended that this invention be limited only by the following claims and equivalents thereof.

What is claimed is:

1. A computerized method comprising:
dividing a current frame into pairs of macroblocks, the current frame occurring in a sequence of interlaced video frames; and
open loop encoding the macroblock pairs to produce an encoded frame, wherein the open loop encoding comprises:
encoding a macroblock pair as separate macroblocks if a motion threshold is not met; and
encoding a macroblock pair as two fields if the motion threshold is met.

2. The computerized method of claim 1 further comprising:
selecting a predictor for each of the macroblock pairs in the current frame, wherein the open loop encoding uses the predictors to encode the macroblock pairs.

3. The computerized method of claim 2, wherein the predictor is selected from macroblock pairs in a different frame of the sequence.

4. The computerized method of claim 3, wherein the different frame is one of a past frame, a future frame, and a combination of a past and future frame.

5. The computerized method of claim 2, wherein the predictor is selected from macroblock pairs in a frame having a different resolution than the current frame.

6. The computerized method of claim 1 further comprising:
applying the open loop encoding to fields within the current frame instead of to each macroblock pair in the current frame.

7. A computerized method comprising:
decoding an encoded frame into macroblock pairs using an open loop decoding, wherein the encoded frame represents an interlaced video frame.

8. The computerized method of claim 7, wherein the decoding comprising:
decoding two fields into a macroblock pair.

9. The computerized method of claim 7, wherein the decoding comprises:
decoding each macroblock pair using a corresponding predictor.

10. A machine-readable medium having instructions to cause a processor to execute a method, the method comprising:
dividing a current frame into pairs of macroblocks, the current frame occurring in a sequence of interlaced video frames; and
open loop encoding the macroblock pairs to produce an encoded frame, wherein the open loop encoding comprises:
encoding a macroblock pair as separate macroblocks if a motion threshold is not met; and
encoding a macroblock pair as two fields if the motion threshold is met.

11. The machine readable medium of claim 10, wherein the method further comprises:
selecting a predictor for each of the macroblock pairs in the current frame, wherein the open loop encoding uses the predictors to encode the macroblock pairs.

12. The machine readable medium of claim 11, wherein the predictor is selected from macroblock pairs in a different frame of the sequence.

13. The machine readable medium of claim 12, wherein the different frame is one of a past frame, a future frame, and a combination of a past and future frame.

14. The machine readable medium of claim 11, wherein the predictor is selected from macroblock pairs in a frame having a different resolution than the current frame.

15. The machine readable medium of claim 1, wherein the method further comprises:
applying the open loop encoding to fields within the current frame instead of to each macroblock pair in the current frame.

16. A machine-readable medium having instructions to cause a processor to execute a method, the method comprising:
decoding an encoded frame into macroblock pairs using an open loop decoding, wherein the encoded frame represents an interlaced video frame.

17. The machine readable medium of claim 16, wherein the decoding comprising:
decoding two fields into a macroblock pair.

18. The machine readable medium of claim 16, wherein the decoding comprises:
decoding each macroblock pair using a corresponding predictor.

19. A system comprising:
a processor coupled to a memory through a bus; and
an encoding process executed from the memory by the processor to cause the processor to divide a current frame into pairs of macroblocks, the current frame occurring in a sequence of interlaced video frames, and to open loop encode the macroblock pairs to produce an encoded frame by encoding a macroblock pair as separate macroblocks if a motion threshold is not met and by encoding a macroblock pair as two fields if the motion threshold is met.

20. The system of claim 19, wherein the encoding process further causes the processor to select a predictor for each of the macroblock pairs in the current frame, wherein the open loop encoding uses the predictors to encode the macroblock pairs.

21. The system of claim 20, wherein the processor selects the predictor from macroblock pairs in a different frame of the sequence.

22. The system of claim 21, wherein the different frame is one of a past frame, a future frame, and a combination of a past and future frame.

23. The system of claim 20, wherein the processor selects the predictor from macroblock pairs in a frame having a different resolution than the current frame.

24. The system of claim 19, wherein the encoding process further causes the processor to open loop encode fields within the current frame instead of open loop encoding each macroblock pair in the current frame.

25. A system comprising:
a processor coupled to a memory through a bus; and
a decoding process executed from the memory by the processor to cause the processor to decode an encoded frame into macroblock pairs using an open loop decoding, wherein the encoded frame represents an interlaced video frame.

26. The system of claim 25, wherein the decoding process causes the processor to decode two fields into a macroblock pair when decoding an encoded frame.

27. The system of claim 25, wherein the decoding process causes the processor to decode each macroblock pair using a corresponding predictor when decoding an encoded frame.

28. An apparatus comprising:
an open loop encoder to encode macroblock pairs in a frame as separate macroblocks if a motion threshold is not met and as a macroblock pair as two fields if the motion threshold is met, wherein the frame occurs in a sequence of interlaced video frames.

29. An apparatus comprising:
an open loop decoder to decode an encoded frame into macroblock pairs, wherein the encoded frame represents an interlaced video frame.
